(19) United States
(12) Patent Application Publication
(10) Pub. No.: US 2007/0188902 A1
(43) Pub. Date: Aug. 16, 2007

(54) Delivering capacity alerts

(75) Inventors: David Patron, Frisco, TX (US); Peter Lowrie, Austin, TX (US); Sreenivasa Gorti, Austin, TX (US); Donald Garofalo, Austin, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures, L.P.

(21) Appl. No.: 11/354,202

(22) Filed: Feb. 13, 2006

(51) Int. Cl. G11B 27/36; G11B 19/00; G06F 12/00; G06F 15/173; G08B 21/00

(52) U.S. Cl. 360/31; 340/679; 709/223; 711/100; 369/24.01

(57) ABSTRACT

Systems and methods to alert content subscribers that content recording space is running low are described. The subscriber is provided a chance to remotely manage their system to accommodate the storage requirements for future, planned recordings. Embodiments can include any type of content recording device, including but not limited to audio, video, data recording devices. In addition to content recording devices and systems, embodiments can include any device or system which may require user/subscriber decisions.

### TECHNICAL FIELD

The inventive subject matter hereof relates to the field of content delivery systems and more specifically to efficiently managing storage capacity of content systems.

### BACKGROUND

Current cable and satellite digital video recorder units rely on predetermined settings to deal with shortages of recording space. These settings include for example deleting stored content if there is no space available to record new content. If all content that can be erased has been removed and if there is no available space for content recording, then the system does not continue recording any new content. After this point, the subscriber may not have realized that his/her content has not been recorded because he/she might not have been alerted to the shortage of space in the system.

### BRIEF DESCRIPTION OF THE DRAWINGS

FIG. 1 illustrates a sample instant message alert according to an embodiment;

FIG. 2 illustrates a sample voice alert according to an embodiment;

FIG. 3 illustrates a sample instant message alert with user selections according to an embodiment;

FIG. 4 illustrates a system incorporating embodiments of the disclosure; and

FIG. 5 shows a diagrammatic representation of machine within which a set of instructions, for causing the machine to perform any one or more of the methodologies discussed herein, may be executed.

### DETAILED DESCRIPTION

In the following detailed description, reference is made to the accompanying drawings that form a part hereof, and in which are shown by way of illustration specific embodiments in which the inventive subject matter can be practiced. It is understood that other embodiments may be utilized and structural changes may be made without departing from the scope of the present disclosure. The inventive subject matter hereof provides systems and methods for efficiently managing content recording systems.

In one embodiment a method includes monitoring available recording space of a recorder device, and communicating an alert to a user of the recorder device. The alert is communicated to the user via a communication network remote from the recording device.

In another embodiment a method provides monitoring available recording space of a recorder, managing content stored in the recorder by applying predefined content management policies, and determining that sufficient recording space is not available to record a pre-selected content. A network location of a user of the recorder is determined, and an alert is communicated to a user of the recorder via the determined network location and communication mode.

A method of controlling a subscription service comprising managing operating parameters of the subscription service by applying predefined management policies, and determining that a subscriber specific selection is desired to perform a future operation of the subscription service. A search is performed to determine a network location of the subscriber and an alert is communicated to the subscriber to notify the subscriber of the desired subscriber specific selection. The alert is communicated to the subscriber at the determined network location or via an alternative network if the network location could not be determined.

A system embodiment provides a recording device to store content, and a notification system to communicate an alert of an operational status of the recording device to a user, wherein the alert is communicated via a communication network remote from the recording device.

According to example embodiments, described in more detail below, systems and methods are provided to alert content subscribers that content recording space is running low, thus giving the subscriber a chance to remotely manage their system to accommodate the storage requirements for future, planned recordings. In contrast to local notification via a play-back device such as a television, embodiments of the disclosure provide for remote notification through a communication medium separate from the recording device and/or play-back device.

Embodiments of the present disclosure provide a system to enhance content recording functionality. Embodiments of the present disclosure can include any type of content recording device. That is, the content recorder can include but is not limited to audio, video, and/or data recording devices. In addition to content recording devices and systems, embodiments of the present disclosure can include any device or system which may require user/subscriber decisions.

One type of content recording device is a Digital Video Recorder (DVR). Embodiments of the present disclosure are described herein using the DVR for illustration. The DVR operation can be improved by allowing subscribers to be away from their home and still be notified that their DVR unit located at the home cannot record their selected programs. The notification can be provided in many ways, including electronic messages such as but not limited to email, Instant Messenger (IM), short message services (SMS), and text to speech voice calls. The subscribers can then log on to a web site (via a PC, or even a cell phone) that can remotely manage their DVR (e.g. delete existing recordings/add and remove scheduled recordings of future programs). The notifications sent via IM, cell phone, voice, or email, can provide some user selectable alternatives to solve a content recording storage problem. For example, the notification can provide suggestions on shows to erase to make space based on previous viewing preferences. This way, the subscriber does not have to necessarily log on to a web site to accommodate the changes.

In one embodiment, before a user's location-based set top box (STB), including but not limited to a DVR, initiates a recording, it can check an amount of available recording space for scheduled content recordings. If there is not enough available space for the new recording, the STB can then check on existing recorded content that could be erased to free up space. The recordings to be erased can be selected by using different pre-defined policies, including starting to erase existing recordings that are marked as “not permanent” and/or based on a recording date of the content—older recordings get erased first. Other state information can also be used, for example not erasing a recording that hasn't been watched yet. For a more advanced implementation, the STB does not have to directly erase shows automatically, but the system can suggest various actions that could be part of the notification, and use confirmation from the subscriber to delete certain shows.

If after deleting all recordings that could be disposed of there is not enough available storage space, then the STB can initiate a process to contact the subscriber in order for the subscriber to decide how to make recording space available in the DVR or to cancel the upcoming recording altogether.

In one operating embodiment, the recording device checks the available recording space before the recording begins, such as a lead time of about 1 to 2 hours. If the device projects that there will not be enough space for the recording then the device contacts an application server. The application server evaluates current policies and preferences set by the consumer with regards to establishing offline contact with the subscriber. These policies may include: precedence on how to determine the communications medium to contact the subscriber (Instant messaging credentials, email address, SMS phone number, analog phone number, etc); schedules on when to use each communication mediums; and how to use presence to determine how to contact the subscriber. For example, determining that the subscriber is using an Instant Messaging client at a specific time.

In one embodiment, the notification functionality is implemented separately as a Web Service (akin to .NET alerts) that utilizes presence information to determine the best way to contact a person. That is, determining the user's current communication location or medium can be leveraged to more efficiently manage alert notifications.

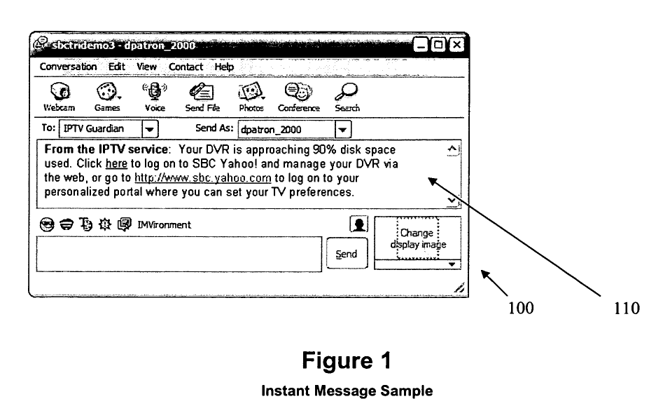

If the user's location is not known, a systematic notification process can be implemented. For example, if the user is logged on to an instant messaging client and is active (e.g. the client is not in a “do not disturb mode”), then the user receives an instant message with the alert information and instructions on how to log on and manage their DVR settings. FIG. 1 illustrates an example instant messaging notification 100. As illustrated, the message from the subscriber service, IPTV, indicates 110 that the DVR is about 90% full. The subscriber is provided a network link to access and select preferences.

If the instant messaging system cannot be used, the server can determine if the user has a message-enabled mobile cell phone turned on. If so, then the user can receive a notification of the DVR alert and instructions on either logging on to a web page to manage the DVR remotely or if the mobile phone has the capability, to start a local application in the phone that allows remote DVR management.

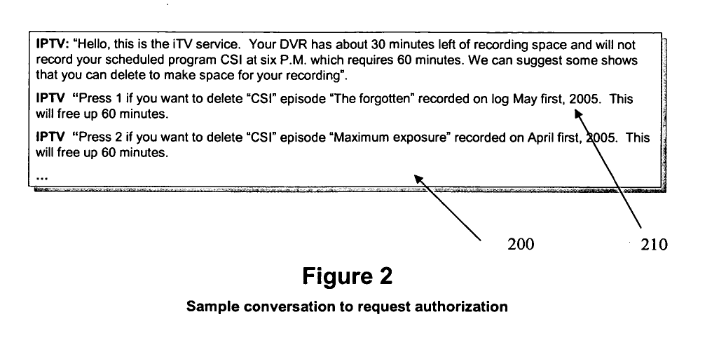

The server initiates a voice call to the user, describing the alert. Referring to FIG. 2, a basic informational voice message notification 200 is illustrated. The notification alerts the user to possible recording problems. In addition to the notification, a voice interaction 210 can be provided to allow the user to change the settings of the recording device interactively. For example, as illustrated in FIG. 2 two interactive options are provided to allow the user to select editing options.

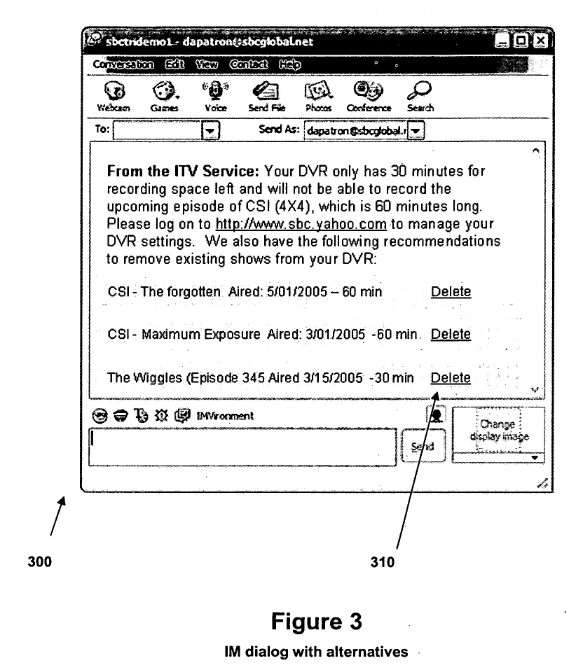

Similarly, the instant messaging notification similar to that of FIG. 1 can be provided with interactive options. As illustrated in FIG. 3, an instant message 300 from the server provides options 310 for the user to select. In the event that the server does not receive an answer before the recording is to take place, and if there is no space left on the DVR, then the recording device will not record the new program.

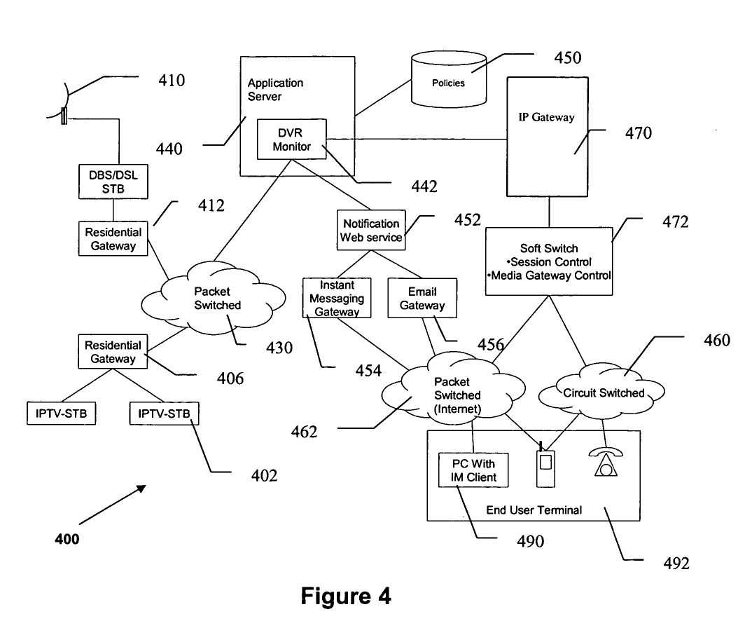

Referring to FIG. 4, one embodiment of a content recording system 400 is described. The system includes a packet-switched-video network 430 over a broadband system, such as a DSL, FTTP or FFTx system. One or more set top boxes 402 provided at a user's residence which can communicate over the packet-switched network 430 via a residential gateway 406. The set top boxes can be pure IP-TV (Internet Protocol TV) set top boxes or combination satellite-IP set top boxes. The set top box includes a recording device, such as memory or other recordable medium (not shown), capable of storing content.

Content to be recorded is provided by a content supplier, such as a satellite provider service shown generally as satellite dish 410, through a residential gateway 412. An application server 440 is provided with a DVR monitor function 442. The application server can manage the recording of content using predefined user policies for database 450. That is, the server can be used by subscribers to configure their preferences for DVR and content retention policies. For example, subscribers can use web-based interfaces to configure a policy repository that holds all the DVR rules. These policies can include which recordings to erase first, which to keep, keep recordings that have not been viewed, etc. These policies can also be synchronized with any policies provided at the set top box.

A notification web service 452 can be provided that is presence-based and routes the alert to an appropriate communication channel. Again, the application server can use presence information provided to determine the user's presence in an IP network. The server can then send an instant message 454 or e-mail 456 over a network 462 (such as the Internet) to a user computer terminal 490 or device 492. Alternatively, or in combination, the server can provide notifications through an IP gateway 470 and control router 472 following a user defined notification protocol, including data or voice notifications network 462 or over a circuit switched network 460.

The disclosure is not limited to set top boxes located at a user residence. For example, the content recording can be maintained remotely at the application server in a subscription based system. Likewise, the application server and policies database can be implemented with the recording device at the user's residence. That is, the notification alerts are processed locally and communicated through the residential gateway to the user. It will be appreciated that the notification can be delivered to the user in a wired or wireless manner.

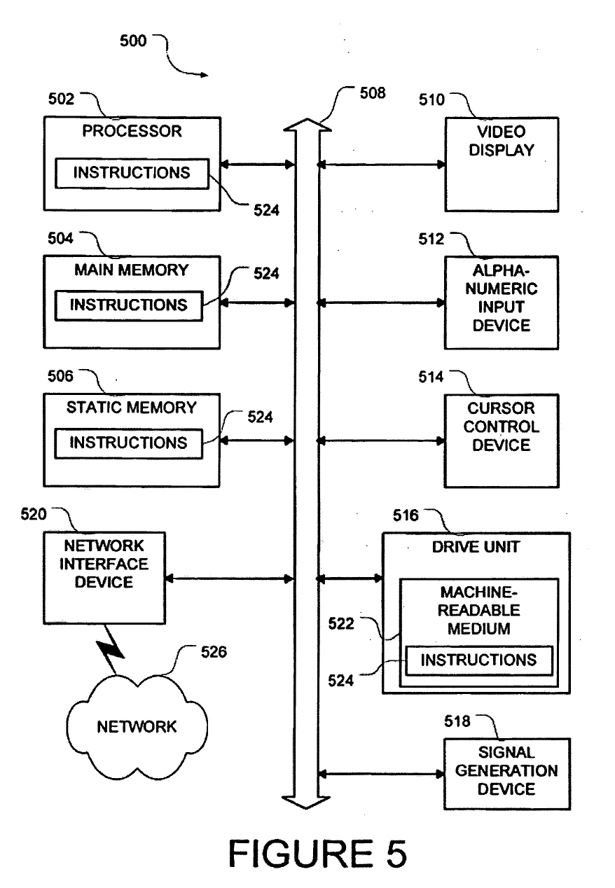

FIG. 5 shows a diagrammatic representation of machine 500 within which a set of instructions, for causing the machine to perform any one or more of the methodologies discussed herein, may be executed. The machine operates as a set top box, a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a digital video recorder (DVR), a personal video recorder (PVR), a Personal Digital Assistant (PDA), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 500 includes a processor 502 (e.g., a central processing unit (CPU), a graphics processing unit (GPU) or both), a main memory 504 and a static memory 506, which communicate with each other via a bus 508. The machine 500 may further include a video display unit 510 (e.g., a liquid crystal display (LCD) or a cathode ray tube (CRT)). The machine 500 can also include an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the machine 500, the main memory 504 and the processor 502 also constituting machine-readable media.

The software 524 may further be transmitted or received over a network 526 via the network interface device 520 utilizing any one of a number of well-known transfer protocols (e.g., HTTP).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although the inventive subject matter has been described with reference to several example embodiments, it may be understood that the words that have been used are words of description and illustration, rather than words of limitation. Changes may be made within the purview of the appended claims, as presently stated and as amended, without departing from the scope and spirit of the inventive subject matter in all its aspects. Although the inventive subject matter has been described with reference to particular means, materials and embodiments, the inventive subject matter is not intended to be limited to the particulars disclosed; rather, the subject matter extends to all functionally equivalent structures, methods, and uses such as are within the scope of the appended claims.

What is claimed is:

1. A method comprising:
determining available recording space of a recorder device; and
communicating an alert to a user of the recorder device, wherein the alert is communicated to the user via a communication network remote from the recording device.

2. The method of claim 1 further comprising:
communicating response options to the user as a part of the alert, wherein the response options provide control options for the recorder device; and
receiving a response from the user to control the recorder device.

3. The method of claim 1 further comprises determining a network location of a user of the recorder device prior to communicating the alert, wherein the alert is communicated to the determined network location.

4. The method of claim 1 wherein the alert comprises an electronic message communicated to a computer, telephone or portable electronic device.

5. A method comprising:
determining that sufficient recording space is not available to record pre-selected content in a recorder;
determining a network location of a user of the recorder; and
communicating an alert to a user of the recorder, wherein the alert is communicated to the user via the determined network location.

6. The method of claim 5 wherein the alert is communicated via a network to a terminal operated by the user.

7. The method of claim 6 wherein the communication comprises either an electronic instant message or an electronic mail message or an interactive voice session.

8. The method of claim 5 wherein the communication comprises a text message communicated to a portable electronic device.

9. The method of claim 5 wherein the communication comprises an audible message communicated to a portable electronic device.

10. The method of claim 5 further comprises:
communicating response options to the user with the alert, wherein the response options provide control options for removing stored content in the recorder; and
processing a response from the user to control the recorder.

11. A method of controlling a subscription service comprising:
managing operating parameters of the subscription service by applying predefined management policies;
determining that a subscriber specific selection is desired to perform an operation of the subscription service;
performing a search to determine a network location of the subscriber; and
communicating an alert to the subscriber to notify the subscriber of the desired subscriber specific selection, wherein the alert is communicated to the subscriber at the determined network location.

12. The method of claim 11 wherein the alert is communicated to the subscriber via an alternative network if the network location could not be determined.

13. The method of claim 11 wherein the subscription service is a content delivery service.

14. The method of claim 13 wherein the content delivery service comprises delivering audio and video content to a recorder located at a subscriber specified location.

15. The method of claim 13 wherein the alert is either a text or a voice message.

16. A recorder system comprising:
a set-top box; and
an application server located remotely from the set-top box, wherein the set-top box stores content and the application server manages the content stored in the set top box by applying predefined content management policies, and communicates an alert to a user of the set top box via a communication network remote from the set top box.

17. A system comprising:
a recording device to store content; and
a notification system to communicate an alert of an operational status of the recording device to a user, wherein the alert is communicated via a communication network remote from the recording device.

18. The system of claim 17 wherein the alert is communicated to a network location where the user has been determined to be present by a network locating system.

19. The system of claim 17 wherein the alert is either a text or a voice message.

20. The system of claim 17 wherein the alert comprises response options for the user to provide control options for removing stored content in the recording device.

21. A device comprising:
an application server to manage operations of a recording device capable of storing content, the application server is configured to apply content retaining policies, and communicate an alert of an operational status of the recording device to a user of the recorder, wherein the alert is communicated via a communication network remote from the recording device.

22. The device of claim 21 wherein the application server determines a network location where the user prior to communicating the alert.

23. The device of claim 21 wherein the alert is either a text or a voice message and comprises response options for the user to provide control options for removing stored content in the recorder.

24. A machine-readable medium storing a set of instructions that, when executed by a machine, cause the machine to:
manage operating parameters of a subscription service by applying predefined management policies;
determine that a subscriber specific selection is desired to perform an operation of the subscription service;
determine a network location of the subscriber; and
communicate an alert to the subscriber to notify the subscriber of the desired subscriber specific selection, wherein the alert is communicated to the subscriber at the determined network location.
